(19) United States
(12) Patent Application Publication
(10) Pub. No.: US 2025/0074190 A1
(43) Pub. Date: Mar. 6, 2025

(54) INFORMATION PROCESSING DEVICE

(71) Applicant: TOYOTA JIDOSHA KABUSHIKI KAISHA, Toyota-shi (JP)

(72) Inventor: Tomoki YOSHIDA, Nagoya-shi (JP)

(73) Assignee: TOYOTA JIDOSHA KABUSHIKI KAISHA, Toyota-shi (JP)

(21) Appl. No.: 18/760,454

(22) Filed: Jul. 1, 2024

(30) Foreign Application Priority Data
Sep. 5, 2023 (JP) 2023-143381

(51) Int. Cl. B60K 35/10

(52) U.S. Cl. CPC B60K 35/10; B60K 2360/128

(57) ABSTRACT

The control unit of the information processing device detects that a specific switch among the plurality of existing switches for operating each of the plurality of devices existing in the vehicle is operated by a predetermined method in which the function of the corresponding device is not exerted. The control unit of the information processing device transmits a command for causing the user terminal used by the user associated with the vehicle to perform a predetermined operation in response to the detection of the operation of the specific switch by the predetermined method.

### CROSS-REFERENCE TO RELATED APPLICATION

This application claims priority to Japanese Patent Application No. 2023-143381 filed on Sep. 5, 2023, incorporated herein by reference in its entirety.

### BACKGROUND

### 1. Technical Field

The present disclosure relates to an information processing device.

### 2. Description of Related Art

There is known a technology in which a dedicated controller is retrofitted to a vehicle and a user terminal is operated through an operation on the controller (see, for example, Japanese Unexamined Patent Application Publication No. 2015-195553 (JP 2015-195553 A)).

### SUMMARY

An object of the present disclosure is to provide a technology capable of safely operating a user terminal without relying on a retrofitted device.

The present disclosure can be regarded as an information processing device mounted on a vehicle. The information processing device in this case includes, for example, a control unit configured to:

detect that a specific switch among a plurality of existing switches for operating a plurality of devices existing in the vehicle is operated by a predetermined method in which a function of a corresponding device is not exerted; and
transmit, in response to detection of an operation on the specific switch by the predetermined method, a command for causing a user terminal associated with a user who drives the vehicle to perform a predetermined action.

The present disclosure can also be regarded as an information processing method in which a computer mounted on a vehicle performs a process of the above information processing device. The present disclosure can also be regarded as an information processing program that causes a computer mounted on a vehicle to perform the above information processing method, or a non-transitory storage medium storing the information processing program.

According to the present disclosure, it is possible to provide the technology capable of safely operating the user terminal without relying on the retrofitted device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a system according to an embodiment;

FIG. 2 is a diagram schematically illustrating an example of a configuration of a vehicle according to the embodiment;

FIG. 3 is a diagram schematically illustrating an example of a software configuration of an in-vehicle terminal according to the embodiment;

FIG. 4 is a diagram schematically illustrating an example of operation data according to the embodiment; and

FIG. 5 is a flowchart illustrating a processing flow executed by the in-vehicle terminal according to the embodiment.

### DETAILED DESCRIPTION OF EMBODIMENTS

As a part of traffic safety, regulations for operation of a user terminal (for example, a mobile terminal such as a smartphone, a tablet terminal, or a mobile phone) while driving a vehicle have been developed. On the other hand, as in the prior art, a technique has been proposed in which a dedicated controller is retrofitted to a vehicle and a user terminal is operated by operating a physical switch provided in the controller.

In the related art, the user needs to obtain a dedicated controller separately from the vehicle. In addition, depending on the type of vehicle, it is assumed that the controller cannot be installed at a position where the driver can easily operate. Therefore, there is a need for a technique for safely operating a user terminal without relying on a retrofitted controller.

Therefore, in the information processing device according to the present disclosure, the control unit detects that a specific switch among the plurality of existing switches for operating each of the plurality of devices existing in the vehicle is operated by a predetermined method in which the function of the corresponding device is not exhibited. The plurality of devices existing in the vehicle are, for example, a power window actuator, a door lock actuator, a shift actuator of a transmission, and the like. Examples of the existing switches corresponding to these switches include a power window switch, a door lock switch, a paddle shift, and the like. Further, the predetermined method in which the function of the corresponding device is not exhibited includes an operation method of closing (or opening) the power window switch in a state where the window is fully closed (or fully opened), an operation method of locking (unlocking) the door lock switch in a state where the door is locked (or unlocked), an operation method of shifting up (or downshifting) the paddle shift in a state where the transmission gear stage is the highest (or lowest) stage, and the like.

When an operation of a specific switch in a predetermined method is detected, the control unit of the information processing device according to the present disclosure transmits a command for causing a terminal (user terminal) associated with a user driving the vehicle to perform a predetermined operation. The predetermined operation may be, for example, an operation of transmitting an e-mail to a pre-registered destination. The content of the mail may be a pre-registered content.

Note that the address and the content of the mail may be changed according to the position of the vehicle at the time when the operation of the specific switch by the predetermined method is performed. As an example, if the location of the vehicle is within a predetermined distance from the user's home, the address and content of the email may be content informing the user's family and home. As another example, if the location of the vehicle is within a predetermined distance from a particular facility, the address and content of the email may be content that informs the user's meeting partner and the location of the vehicle.

Further, the address and content of the mail may be changed according to the type of the specific switch. As an example, the address and content of the mail may be changed between the case where the specific switch is a power window switch, the case where the switch is a door lock switch, and the case where the switch is a paddle shift. Further, the address and content of the mail may be changed according to the type of the predetermined method. As an example, the address and the content of the mail may be changed by an operation method of closing the power window switch in a state where the window is fully closed and an operation method of opening the power window switch in a state where the window is fully opened.

According to the information processing device of the present disclosure, it is possible to operate a user terminal by operating a switch existing in a vehicle by a predetermined method. Therefore, it is not necessary to retrofit the vehicle with a dedicated controller. This makes it possible to safely operate the user terminal without relying on a retrofitted controller. Further, according to the information processing device of the present disclosure, since the user terminal can be operated by using an existing switch that is familiar to the user, it is also expected to further enhance convenience and safety.

Hereinafter, an embodiment of the present disclosure will be described with reference to the drawings. The hardware configuration, the module configuration, the functional configuration, and the like described in the following embodiments are not intended to limit the technical scope of the disclosure only thereto unless otherwise specified.

### Embodiment

In the present embodiment, an example in which the information processing device according to the present disclosure is applied to a system for providing a service (hereinafter, sometimes referred to as “terminal operation service”) for operating the user terminal 300 using an existing switch in a vehicle will be described.

### Summary of System

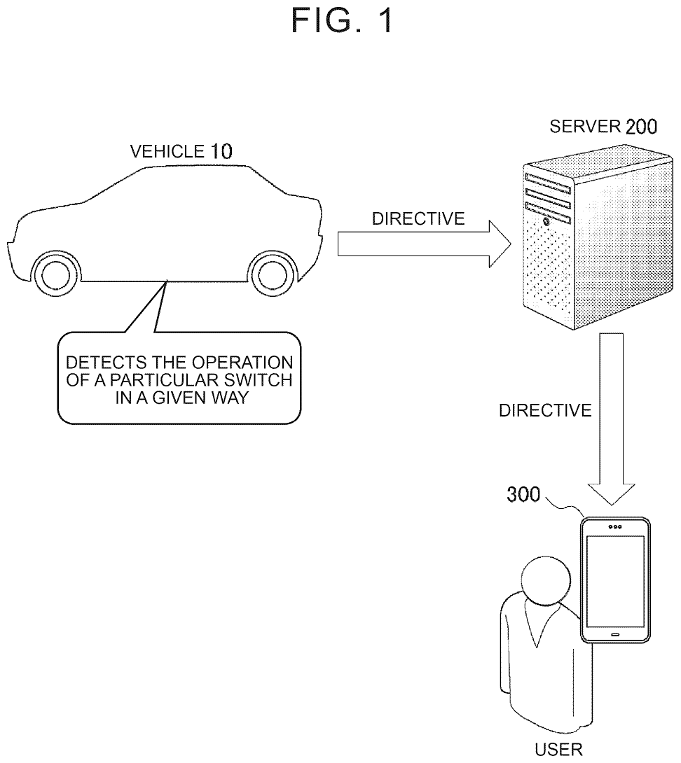

FIG. 1 is a diagram illustrating an outline of a system according to the present embodiment. The system according to the present embodiment includes a vehicle 10, a server 200, and a user terminal 300. The vehicle 10 (an in-vehicle terminal 100 to be described later), the server 200, and the user terminal 300 are connected through an out-of-vehicle network. The out-of-vehicle network is, for example, a WAN or another communication network, which is a global public communication network such as the Internet.

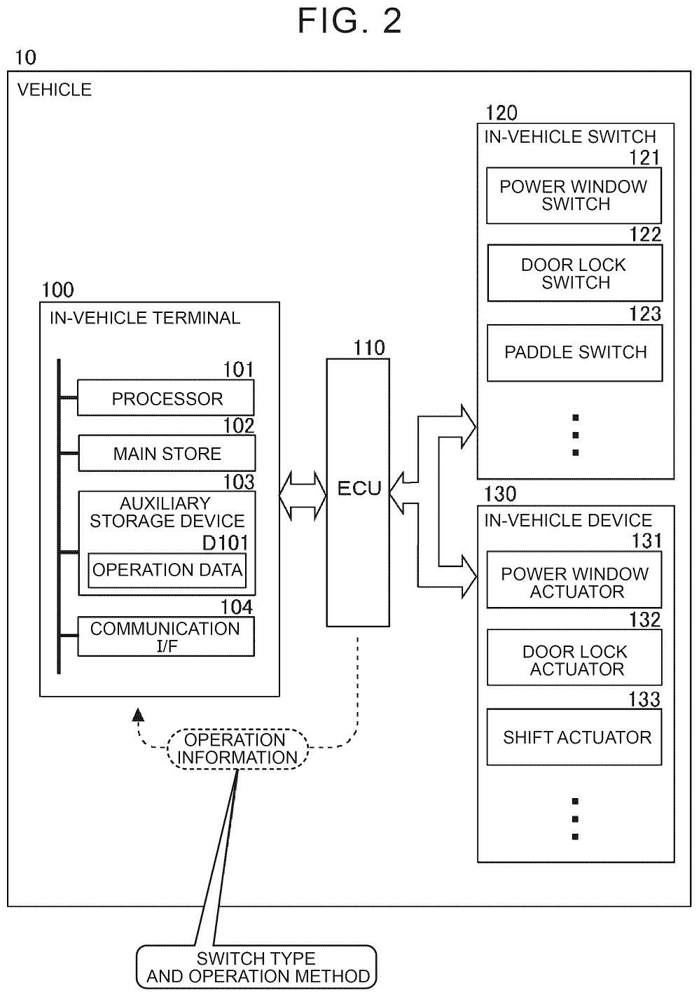

The vehicle 10 is an automobile driven by a user of the user terminal 300. As illustrated in FIG. 2, the vehicle 10 according to the present embodiment includes an in-vehicle terminal 100, an Electronic Control Unit (ECU) 110, an in-vehicle switch 120, and an in-vehicle device 130. The in-vehicle terminal 100, ECU 110, the in-vehicle switch 120, and the in-vehicle device 130 are connected through an in-vehicle network such as a network based on standards such as Controller Area Network (CAN), Local Interconnect Network (LIN), or FlexRay.

The in-vehicle device 130 is an existing device in the vehicle 10. As an example, the in-vehicle device 130 includes a power window actuator 131, a door lock actuator 132, a shift actuator 133, and the like. The power window actuator 131 is an actuator that opens and closes a window of the vehicle 10. The door lock actuator 132 is an actuator that locks and unlocks the door of the vehicle 10. The shift actuator 133 is an actuator that shifts the transmission of the vehicle 10.

The in-vehicle switch 120 is a plurality of existing switches for operating each of the in-vehicle devices 130. In one example, the in-vehicle switch 120 includes a power window switch 121 for operating the power window actuator 131, a door lock switch 122 for operating the door lock actuator 132, a paddle shift 123 for operating the shift actuator 133, and the like.

Note that the existing devices and switches in the present embodiment are devices and switches installed by the manufacturer at the time of manufacturing the vehicle 10 or the like. The existing devices and switches are not limited to the devices and switches illustrated in FIG. 2, and may be appropriately changed according to the vehicle type and the like.

ECU 110 is a computer that controls the in-vehicle device 130 in response to manipulation of the in-vehicle switch 120. In the present embodiment, ECU 110 also has a function of transmitting operation data to the in-vehicle terminal 100 when the in-vehicle switch 120 is operated. The operation information includes information indicating the type of the in-vehicle switch 120 (a function as a “target switch” according to the present disclosure) (hereinafter, may be referred to as “type information”) and information indicating an operation method (hereinafter, may be referred to as “operation method information”).

The operation method information may include state information indicating the state of the in-vehicle device 130 at the time of starting the operation of the in-vehicle switch 120 and operation content information indicating the operation content of the in-vehicle switch 120. Note that the state of the in-vehicle device 130 at the operation start time of the in-vehicle switch 120 can be referred to as the state of the device to be driven by the in-vehicle device 130 at the operation start time of the in-vehicle switch 120. For example, the state of the power window actuator 131 may be an open/closed state (for example, a fully open state, a fully closed state, a half open state, or the like) of a window to be driven. The state information in this case may be information indicating whether the window of the vehicle 10 is in the fully opened state, the fully closed state, or the half-opened information. ECU 110 may determine the opening/closing status of the window of the vehicle 10 based on a detected signal of a pulse sensor or the like incorporated in the power window actuator 131.

Further, the state of the door lock actuator 132 may be a state (for example, a locked state (lock information), an unlocked state, or the like) of a door (a locking and unlocking device incorporated in a door) to be driven. The state information in this case may be information indicating whether the door of the vehicle 10 is in a locked state or an unlocked state. ECU 110 may determine the state of the door of the vehicle 10 based on a position sensor or the like incorporated in the door or the door lock actuator 132.

Further, the state of the shift actuator 133 may be a shift position of a transmission to be driven (which of a plurality of gear stages is a gear stage). The state information in this case may be information indicating a shift position of the transmission of the vehicle 10. ECU 110 may determine the shift position of the transmission of the vehicle 10 in accordance with the shift actuator 133 or a shift position sensor incorporated in the transmission.

The operation content information is information indicating how the in-vehicle terminal 100 to be operated is operated by the user. As an example, the operation content information when the in-vehicle switch 120 to be operated is the power window switch 121 may be information indicating either a closing operation or an opening operation. Further, the operation content information when the in-vehicle switch 120 to be operated is the door lock switch 122 may be information indicating either a locking operation (lock operation) or an unlocking operation (unlock operation). Further, the operation content information in the case where the in-vehicle switch 120 to be operated is the paddle shift 123 may be information indicating either the shift-up operation or the shift-down operation.

The in-vehicle terminal 100 is a computer mounted on the vehicle 10, and is an example of an “information processing device” according to the present disclosure. As illustrated in FIG. 2, the in-vehicle terminal 100 according to the present embodiment includes a processor 101, a main storage device 102, an auxiliary storage device 103, and a communication interface 104.

The processor 101 is an arithmetic processor such as a CPU (Central Processing Unit) or a DSP (Digital Signal Processor). The processor 101 loads a program stored in the auxiliary storage device 103 into the main storage device 102 and executes the program, and controls the in-vehicle terminal 100 through the execution.

The main storage device 102 includes, for example, RAM (Random Access Memory) and ROM (Read Only Memory). The main storage device 102 provides a storage area and a work area for loading programs stored in the auxiliary storage device 103. The main storage device 102 is used as a buffer for arithmetic processing by the processor 101.

The auxiliary storage device 103 is, for example, Erasable Programmable ROM (EPROM) or Hard Disk Drive (HDD). The auxiliary storage device 103 may include a removable medium, that is, a portable recording medium. The removable medium is, for example, a disc recording medium such as Universal Serial Bus (USB) memory, Compact Disc (CD), or Digital Versatile Disc (DVD). The auxiliary storage device 103 stores various programs, data used by the processor 101 when executing the programs, and the like. The program stored in the auxiliary storage device 103 includes, in addition to Operating System (OS), a dedicated program for causing the processor 101 to execute a process related to the operation of the user terminal 300. The data stored in the auxiliary storage device 103 includes operation data D101 and the like which will be described later. In the present embodiment, the auxiliary storage device 103 that stores the operation data D101 corresponds to a “storage unit” according to the present disclosure.

The communication interface 104 connects the in-vehicle terminal 100 to an out-of-vehicle network. In one instance, the communication interfaces 104 connect to an out-of-vehicle network using a radio communication scheme such as a mobile communication scheme (e.g., Long Term Evolution (LTE), LTE-Advanced, 5th Generation (5G), or 6th Generation (6G), or the like), or Wi-Fi. The communication interface 104 communicates with the server 200 through a network. The communication interface 104 connects the in-vehicle terminal 100 to the in-vehicle network. The communication interfaces 104 communicate with ECU 110 through in-vehicle networking.

When receiving the operation information transmitted from ECU 110, the in-vehicle terminal 100 according to the present embodiment verifies, based on the operation information and the operation data D101 stored in the auxiliary storage device 103, whether the operation of the in-vehicle switch 120 as an operation target corresponds to an operation by a predetermined method of a particular switch. The particular switch is at least one of the in-vehicle switches 120 and is an in-vehicle switch 120 pre-designated by the user. The predetermined method is an operation method in which the function of the in-vehicle device 130 corresponding to the specific switch is not exerted. Details of the specific switch and the predetermined method will be described later. When the operation of the in-vehicle switch 120 serving as an operation target corresponds to an operation by a predetermined method of a specific switch, the in-vehicle terminal 100 transmits a command for causing the user terminal 300 to perform a predetermined operation to the server 200. The predetermined operation is an operation registered in advance by the user, and details thereof will be described later.

Referring back to FIG. 1, the server 200 is a computer operated by a provider of a terminal operation service. The server 200 according to the present embodiment has a function of receiving a command transmitted from the in-vehicle terminal 100 and transmitting the received command to the user terminal 300.

The user terminal 300 is a portable computer (for example, a smartphone, a tablet terminal, a mobile phone, or the like) used by a user who drives the vehicle 10. The user terminal 300 according to the present embodiment has a function of receiving a command transmitted from the server 200 and performing the predetermined operation in accordance with the received command.

### Software Configuration of the In-Vehicle Terminal

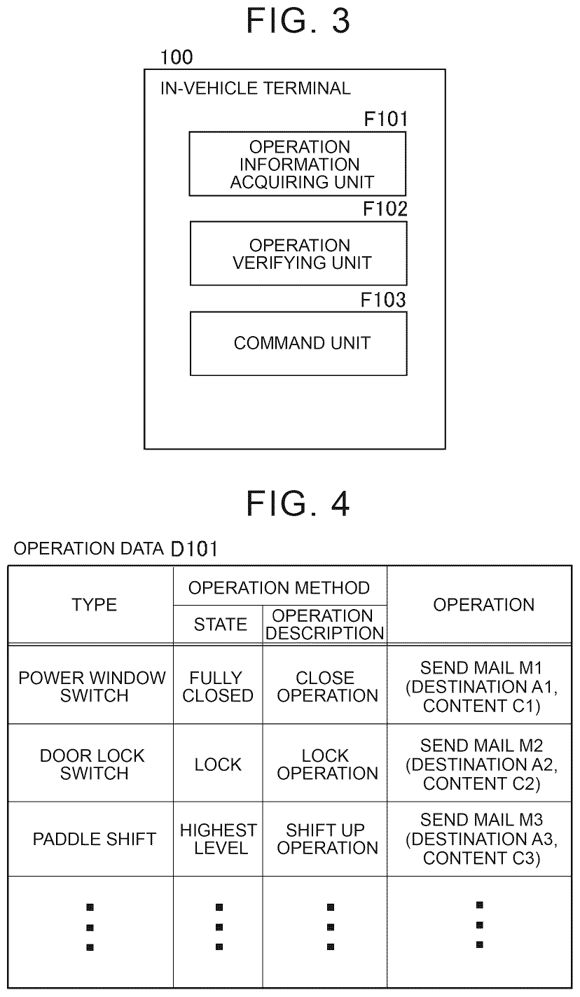

FIG. 3 is a diagram schematically illustrating an example of a software configuration of the in-vehicle terminal 100 according to the present embodiment. The processor 101 of the in-vehicle terminal 100 executes an instruction included in a program of the auxiliary storage device 103. As a result, the in-vehicle terminal 100 operates as a computer including the operation information acquiring unit F101, the operation verifying unit F102, and the command unit F103 as software modules. At least a part of the operation information acquiring unit F101, the operation verifying unit F102, and the command unit F103 may be realized by hardware circuitry such as Application Specific Integrated Circuit (ASIC) or Field Programmable Gate Array (FPGA).

The operation information acquiring unit F101 acquires the operation information transmitted from ECU 110 through the communication interface 104. As described above, the operation information includes type information (information indicating the type of the in-vehicle switch 120 that is the operation target) and operation method information (information indicating the operation method of the in-vehicle switch 120 that is the operation target). The operation information acquired by the operation information acquiring unit F101 is passed to an operation verifying unit F102, which will be described later.

The operation verifying unit F102 verifies, based on the operation information received from the operation information acquiring unit F101, whether the operation of the in-vehicle switch 120 as an operation target corresponds to an operation of a particular switch by a predetermined method. The verification is performed by collating information included in the operation information with information registered in the operation data D101 of the auxiliary storage device 103.

A specific embodiment of the operation data D101 will now be described. FIG. 4 is a diagram schematically illustrating an exemplary operation data D101. The operation data D101 according to the present embodiment is an example of “association information” according to the present disclosure, and includes at least one record for each type of the in-vehicle switch 120 corresponding to a particular switch. Each record includes a plurality of fields such as a type field, an operation method field, and an operation field.

In the type field, information indicating the type of the in-vehicle switch 120 designated as a specific switch is registered. In the example illustrated in FIG. 4, the name (for example, “power window switch”, “door lock switch”, and “paddle shift”) of the in-vehicle switch 120 designated as a specific switch is registered in the type field, but an identifier other than the name may be registered.

In the operation method field, information defining a predetermined method is registered. In the example illustrated in FIG. 4, the operation method field is divided into two subfields: a state field in which information defining the state of the in-vehicle device 130 at the start of the operation of the specific switch is registered, and an operation content field in which information defining the operation content of the specific switch is registered.

Here, in the example illustrated in FIG. 4, when the specific switch is the power window switch 121, information indicating that the window of the vehicle 10 is in the fully closed state is registered in the state field, and information indicating the closing operation of the power window switch 121 is registered in the operation content field. In this case, a method of closing the power window switch 121 in a fully closed state of the window of the vehicle 10 (an operation method in which the function of closing the window by the power window actuator 131 is not performed) is registered as a predetermined method.

In the example illustrated in FIG. 4, when the specific switch is the door lock switch 122, information indicating that the door of the vehicle 10 is in the locked state is registered in the state field, and information indicating the locking operation of the door lock switch 122 is registered in the operation content field. In this case, a method of locking the door lock switch 122 in the locked state of the door of the vehicle 10 (an operation method in which the function of locking the door by the lower actuator is not exerted) is registered as a predetermined method.

In the example illustrated in FIG. 4, when the specific switch is the paddle shift 123, information indicating that the transmission of the vehicle 10 is in the highest stage state is registered in the state field, and information indicating the shift-up operation of the paddle shift 123 is registered in the operation content field. In this case, a method of shifting up the paddle shift 123 in a state where the transmission of the vehicle 10 is at the highest stage (an operation method in which the function of shifting up the transmission by the shift actuator 133 is not performed) is registered as a predetermined method.

Note that the predetermined method is not limited to the example illustrated in FIG. 4, and can be flexibly changed according to the embodiment. For example, the predetermined method when the specific switch is the power window switch 121 may be an operation method of opening the power window switch 121 in a fully opened state. However, in consideration of convenience in bad weather such as rainy weather, an operation method of closing the power window switch 121 in a fully closed state is suitable as a predetermined method. In addition, a predetermined method when the specific switch is the door lock switch 122 may be an operation method of unlocking the door lock switch 122 in an unlocked state of the door. However, in consideration of safety during traveling of the vehicle 10, an operation method in which the door locks the door lock switch 122 in a locked state is suitable as a predetermined method. Also, the predetermined method in the case where the specific switch is the paddle shift 123 may be an operation method in which the transmission downshifts the paddle shift 123 in the state of the lowest stage.

It is assumed that the type and the predetermined method of the in-vehicle switch 120 set for the specific switch are designated (selected) in advance by the user. At this time, the in-vehicle terminal 100 may present a list of types and predetermined methods of the in-vehicle switch 120 that can be selected as a specific switch to the user, and may cause the user to designate (select) any type and predetermined method from the list.

Next, in the operation field, information indicating an operation (predetermined operation) to be performed by the user terminal 300 when an operation by a predetermined method of a specific switch is performed is registered. In the example illustrated in FIG. 4, mail transmission is registered as a predetermined operation in the operation field. In this case, the address and the content (body) of the mail are also registered in the operation field. Note that the address and contents of the mail may be registered in advance by the user. As an example, the user may register the address and content of the mail in the in-vehicle terminal 100 through the user terminal 300. As another example, the address and the content of the mail may be registered in the in-vehicle terminal 100 by the user through an in-vehicle input device (for example, a display audio or a touch panel display of a car navigation system). As another example, the address and the content of the mail may be registered in the in-vehicle terminal 100 through a dedicated website provided by the server 200 by the user. At this time, the user may register different destinations and contents in the in-vehicle terminal 100 for each type of the in-vehicle switch 120 designated as a specific switch.

In the example illustrated in FIG. 4, a plurality of types of in-vehicle switches 120 such as the power window switch 121, the door lock switch 122, and the paddle shift 123 are registered as specific switches, but the type of in-vehicle switch 120 registered as a specific switch may be one type. Further, in the example shown in FIG. 4, although the transmission of the mail is exemplified as a predetermined operation to be performed by the user terminal 300, an operation other than the transmission of the mail (for example, making a call to the other party designated by the user or reading out the contents (body text) of the mail received by the user terminal 300) may be used.

Returning to the explanation of FIG. 3, the operation verifying unit F102 verifies whether the operation method of the switch as the operation target corresponds to the operation by the predetermined method of the particular switch by collating the information included in the operation information with the information included in the operation data D101 illustrated in FIG. 4. In the verification, the operation verifying unit F102 first verifies the type of the in-vehicle switch 120 that is the operation target, using the type information included in the operation information. Specifically, the operation verifying unit F102 accesses the operation data D101 of the auxiliary storage device 103 and determines whether there is a record in which information matching the type information included in the operation information is registered in the type field. When the record in which the type information included in the operation information matches the information registered in the type field is included in the operation data D101, the operation verifying unit F102 determines that the type of the in-vehicle switch 120 to be operated has been successfully verified. On the other hand, when the record in which the type information included in the operation information matches the information registered in the type field is not included in the operation data D101, the operation verifying unit F102 determines that the verification of the type of the in-vehicle switch 120 that is the operation target has failed.

When the type of the in-vehicle switch 120 that is the operation target is successfully verified, the operation verifying unit F102 uses the operation method information included in the operation information to verify the operation method of the in-vehicle switch 120 that is the operation target. Specifically, the operation verifying unit F102 first determines whether the state information included in the operation method information matches the information registered in the state field of the target record (the record in which the information matching the type information included in the operation information is registered in the type field). As an example, when the operation data D101 shown in FIG. 4 is stored in the auxiliary storage device 103 and the in-vehicle switch 120 to be operated is the power window switch 121, if the state information is information indicating the fully closed state of the window, it may be determined that the state information included in the operation method information matches the information registered in the state field of the target record.

When there are a plurality of target records in which information matching the type information is registered in the type field among the records registered in the operation data D101, the operation verifying unit F102 may determine whether the state information included in the operation method information matches the information registered in the state fields of the plurality of target records.

When it is determined that the state information included in the operation method information matches the information registered in the state field of the target record, the operation verifying unit F102 determines whether the operation content information included in the operation method information matches the information registered in the operation content field of the target record. As an example, when the operation data D101 shown in FIG. 4 is stored in the auxiliary storage device 103 and the in-vehicle switch 120 to be operated is the power window switch 121, if the operation method information is information indicating a closing operation of the power window switch 121, it may be determined that the operation content information included in the operation method information matches the information registered in the operation content field of the target record.

If, among the records registered in the operation data D101, information matching the type information is registered in the type field, and information matching the state information is registered in the state field, there are a plurality of target records, the operation verifying unit F102 may determine whether the operation content information included in the operation method information matches the information registered in the operation content field of each of the plurality of target records.

When it is determined that the state information included in the operation method information matches the information registered in the state field of the target record and it is determined that the operation content information included in the operation method information matches the information registered in the operation content field of the target record, the operation verifying unit F102 determines that the operation method of the in-vehicle switch 120 as the operation target has been successfully verified. On the other hand, when it is determined that the state information included in the operation method information does not match the information registered in the state field of the target record, and/or it is determined that the operation content information included in the operation method information does not match the information registered in the operation content field of the target record, the operation verifying unit F102 determines that the verification of the operation method of the in-vehicle switch 120 as the operation target has failed.

When the verification of the type of the in-vehicle switch 120 that is the operation target and the verification of the operation method of the in-vehicle switch 120 that is the operation target are successful, the operation verifying unit F102 determines that the operation of the in-vehicle switch 120 that is the operation target corresponds to the operation by the predetermined method of the particular switch. Then, the verification result (verification success) is passed from the manipulation verifying unit F102 to the command unit F103. At this time, the information about the target record that is finally left is also passed from the operation verifying unit F102 to the command unit F103. The final remaining target record is a target record in which information matching the type information included in the operation information is registered in the type field, information matching the state information included in the operation method information is registered in the state field, and information matching the operation content information included in the operation method information is registered in the operation content field (hereinafter, sometimes referred to as “matching record”).

The command unit F103 generates a command for causing the user terminal 300 to perform a predetermined operation in response to the verification of the type of the in-vehicle switch 120 that is the operation target and the verification of the operation methods of the in-vehicle switch 120 that is the operation target. Specifically, the command unit F103 generates a command in accordance with information (information indicating a predetermined operation) registered in the operation field of the matching record received from the operation verifying unit F102. Here, when the predetermined operation registered in the operation field of the conforming record is the sending of the mail, the command unit F103 may generate a command including the destination and the content registered in the operation field. The command generated by the command unit F103 may include the address of the user terminal 300. The command unit F103 transmits the generated command to the servers 200 through the communication interfaces 104. In this case, the server 200 transmits the command received from the in-vehicle terminal 100 to the user terminal 300. Then, the user terminal 300 performs a predetermined operation according to the command received from the server 200.

### Processing Flow

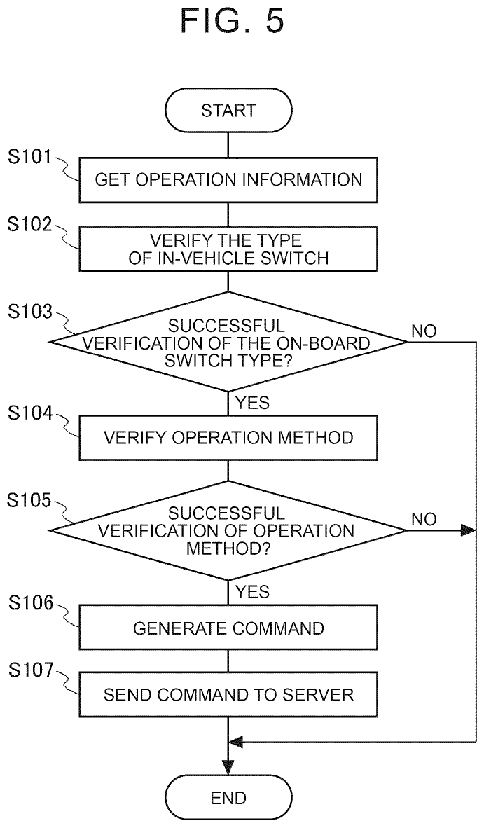

Next, a flow of processing executed by the in-vehicle terminal 100 according to the present embodiment will be described with reference to FIG. 5. FIG. 5 is a flow chart showing a process executed by the in-vehicle terminal 100 triggered by reception of the manipulation data transmitted from ECU 110. The execution subject of the processing routine of FIG. 5 is the processor 101 of the in-vehicle terminal 100, and the software module of the in-vehicle terminal 100 is used as the execution subject.

In the processing routine of FIG. 5, when the operation information transmitted from ECU 110 is received by the communication interface 104 of the in-vehicle terminal 100, the processor 101 of the in-vehicle terminal 100 operates as the operation information acquiring unit F101, and obtains the operation information through the communication interface 104 (S101). When the operation information acquiring unit F101 finishes executing S101 processing, the processor 101 operates as the operation verifying unit F102 to execute S102 processing.

In S102, the operation verifying unit F102 uses the type information included in the operation information to verify the type of the in-vehicle switch 120 that is the operation target. Specifically, the operation verifying unit F102 accesses the operation data D101 of the auxiliary storage device 103 and determines whether there is a record in which information matching the type information included in the operation information is registered in the type field. The operation verifying unit F102 executes the processing of S103 when the processing of S102 is completed.

In S103, the operation verifying unit F102 determines whether the type of the in-vehicle switch 120 to be operated has been successfully verified. At this time, if the record in which the type information included in the operation information matches the information registered in the type field is not included in the operation data D101, the operation verifying unit F102 determines that the type of the in-vehicle switch 120 that is the operation target has failed to be verified (negative determination in S103). In this case, the execution of this processing routine is ended. On the other hand, if the operation data D101 includes a record in which information matching the type information included in the operation information is registered in the type field, the operation verifying unit F102 determines that the type of the in-vehicle switch 120 that is the operation target has been successfully verified (affirmative determination in S103). In this situation, the operation verifying unit F102 executes S104 process.

In S104, the operation verifying unit F102 verifies the operation methods of the in-vehicle switches 120 that are the operation targets. Specifically, the operation verifying unit F102 determines whether the state information included in the operation method information matches the information registered in the state field of the target record (the record in which the information matching the type information included in the operation information is registered in the type field). The operation verifying unit F102 determines whether the operation content information included in the operation method information matches the information registered in the operation content field of the target record. The operation verifying unit F102 executes the processing of S105 when the processing of S104 is completed.

In S105, the operation verifying unit F102 determines whether or not the operation methods of the in-vehicle switch 120 that are the operation targets have been successfully verified. At this time, if the state information included in the operation method information does not match the information registered in the state field of the target record and/or the operation content information included in the operation method information does not match the information registered in the operation content field of the target record, the operation verifying unit F102 determines that the verification of the operation method of the in-vehicle switch 120 as the operation target has failed (negative determination in S105). In this case, the execution of this processing routine is ended. On the other hand, if the state information included in the operation method information matches the information registered in the state field of the target record and the operation content information included in the operation method information matches the information registered in the operation content field of the target record, the operation verifying unit F102 determines that the verification of the operation method of the in-vehicle switch 120 as the operation target has succeeded (affirmative determination is made in S105). In this situation, the processor 101 of the in-vehicle terminal 100 operates as the command unit F103 to execute S106 process.

In S106, the command unit F103 generates a command for causing the user terminal 300 to perform a predetermined operation in response to the verification of the type of the in-vehicle switch 120 that is the operation target and the verification of the operation methods of the in-vehicle switch 120 that is the operation target. Specifically, the command unit F103 generates a command in accordance with information (information indicating a predetermined operation) registered in an operation field of a matching record (a target record in which information matching the type information included in the operation information is registered in the type field, information matching the state information included in the operation method information is registered in the state field, and information matching the operation content information included in the operation method information is registered in the operation content field). When the command unit F103 finishes executing S106 process, it executes S107 process.

In S107, the command unit F103 transmits the command generated by S106 to the servers 200 through the communication interfaces 104. When the command unit F103 finishes executing S107 processing, the execution of this processing routine is ended.

### Operation and Effect of Embodiments

The in-vehicle terminal 100 of the above-described embodiment transmits a command for causing the user terminal 300 to perform a predetermined operation to the user terminal 300 through the server 200 in response to an operation by a predetermined method of the in-vehicle switch 120 corresponding to a specific switch being performed. As a result, the user terminal 300 can perform a predetermined operation in accordance with the command.

Therefore, according to the in-vehicle terminal 100 of the present embodiment, the user can operate the user terminal 300 by operating the in-vehicle switch 120 corresponding to a specific switch by a predetermined method. Thus, the user can operate the user terminal 300 without gazing at the user terminal 300 while driving the vehicle 10. Further, since the in-vehicle switch 120 is an existing switch in the vehicle 10, it is not necessary to retrofit a dedicated controller or the like to the vehicle 10. That is, the user can safely operate the user terminal 300 without depending on a retrofitted controller or the like. Further, the user can operate the user terminal 300 by using the existing in-vehicle switch 120 which is familiar to the user, and therefore, the user can be expected to further enhance convenience and safety.

### OTHER

The above-described embodiment is merely an example, and the present disclosure can be appropriately modified and implemented without departing from the gist thereof. For example, in the above-described embodiment, an example has been described in which an operation (predetermined operation) to be performed by the user terminal 300 for each type of the in-vehicle switch 120 designated as a specific switch is defined, but an operation (predetermined operation) to be performed by the user terminal 300 for each operation method (predetermined method) of the in-vehicle switch 120 designated as a specific switch may be defined. As an example, a predetermined operation different between a case where the closing operation of the power window switch 121 is performed in the fully closed state of the window and a case where the opening operation of the power window switch 121 is performed in the fully opened state of the window may be defined. Further, an operation (predetermined operation) to be performed by the user terminal 300 may be defined in accordance with the position of the vehicle 10 at the time when the operation by the predetermined method of the specific switch is performed. As an example, a predetermined operation different between a case where the position of the vehicle 10 at the time when the operation by the predetermined method of the specific switch is performed is in the vicinity of the user's home (for example, in a range of several tens of meters to several hundreds of meters from the home) and a case where the position is away from the user's home may be defined.

Further, in the above-described embodiment, an example has been described in which the verification processing of the type and the operation method of the in-vehicle switch 120 serving as the operation target is performed by the in-vehicle terminal 100, but the verification processing may be performed by the server 200. In this case, the server 200 may acquire the operation information from the in-vehicle terminal 100 and perform the verification process. Then, in response to the successful verification processing, the server 200 may transmit a command for causing the user terminal 300 to perform a predetermined operation. In this case, the server 200 functions as an “information processing device” according to the present embodiment.

Further, in the above-described embodiment, the instruction from the in-vehicle terminal 100 to the user terminal 300 is transmitted via the server 200, but when the short-range wireless communication (for example, the wireless communication of BLE standard or NFC) is established between the in-vehicle terminal 100 and the user terminal 300, the direct instruction may be transmitted from the in-vehicle terminal 100 to the user terminal 300.

Further, the processes described as being executed by one device may be shared and executed by a plurality of devices. Alternatively, the processes described as being executed by different devices may be executed by one device. In the computer system, it is possible to flexibly change the hardware configuration for implementing each function.

What is claimed is:

1. An information processing device comprising a control unit configured to:
detect that a specific switch among a plurality of existing switches for operating a plurality of devices existing in a vehicle is operated by a predetermined method in which a function of a corresponding device is not exerted; and
transmit, in response to detection of an operation on the specific switch by the predetermined method, a command for causing a user terminal used by a user associated with the vehicle to perform a predetermined action.

2. The information processing device according to claim 1, wherein the detection of the operation on the specific switch by the predetermined method includes:
acquiring, when any one of the existing switches is operated, a type and an operation method of a target switch that is the operated existing switch;
checking, based on the type of the target switch, whether the target switch corresponds to the specific switch;
checking, based on the operation method of the target switch, whether the operation method of the target switch corresponds to the predetermined method; and
determining that the specific switch is operated by the predetermined method in response to successful check on the type and the operation method of the target switch.

3. The information processing device according to claim 2, further comprising a storage unit configured to store association information in which the type and the predetermined method of the specific switch are associated, wherein the control unit is configured to check the type and the operation method of the target switch based on the association information in the storage unit.

4. The information processing device according to claim 3, wherein:
the association information stored in the storage unit is information in which the predetermined action is associated with the type and the predetermined method of the specific switch; and
the control unit is configured to transmit, to the user terminal, the command for causing the user terminal to perform the predetermined action included in the association information in the storage unit when the operation on the specific switch by the predetermined method is detected.

5. The information processing device according to claim 1, wherein:
the specific switch is a power window switch; and
the predetermined method is an operation method for closing the power window switch in a state in which a window of the vehicle is fully closed.
